(19) United States
(12) Patent Application Publication
(10) Pub. No.: US 2017/0273255 A1
(43) Pub. Date: Sep. 28, 2017

(54) MULTILAYER PLANT CULTIVATION SYSTEM USING NATURAL LIGHT AND ARTIFICIAL LIGHT

(71) Applicant: Agricultural Corporation Manna Cea Co., Ltd., Daejeon (KR)

(72) Inventors: Aaron PARK, Daejeon (KR); Jungi Lim, Daejeon (KR)

(21) Appl. No.: 15/505,165

(22) PCT Filed: Jun. 16, 2015
(86) PCT No.: PCT/KR2015/006096

§ 371 Date: Feb. 20, 2017

(30) Foreign Application Priority Data
Aug. 20, 2014 (KR) 10-2014-0108242

(51) Int. Cl. A01G 9/20; A01G 31/06

(52) U.S. Cl. CPC A01G 9/20; A01G 31/06

(57) ABSTRACT

An embodiment of the present invention relates to a plant cultivation system using natural light and artificial light and, more specifically, to a multilayer plant cultivation system having multiple layers of which the upper layer uses natural lighting and the lower layer uses artificial lighting, thereby cultivating plants. According to one embodiment of the present invention, the plant cultivation system has a cultivation zone formed in multiple layers of which the uppermost layer uses natural lighting and the lower layer uses artificial lighting, so as to perform plant cultivation, thereby providing an effect of maximizing the efficiency of a plant cultivation space.

### TECHNICAL FIELD

The disclosure relates to a plant cultivation system using natural light and artificial light, and more particularly to a multilayer plant cultivation system which comprises a multilayer structure of which an upper layer uses natural light and a lower layer artificial light for cultivating plants thereon.

### BACKGROUND ART

A description, which will be given hereinafter, is provided to aid in understanding of the background of the disclosure and should not be interpreted as conventional technology known to those skilled in the art.

In general, the growth and development of plants may be promoted or suppressed by an exposure to light, and growth conditions of plants may be changed according to effects of the light, i.e., synthesis of special functional materials in the plants may be improved according to a light condition.

Recently, plant cultivation systems, which artificially construct plant growth conditions in a restricted space and control plant growth speed so as to achieve mass production of plants, have been vigorously researched and developed, as a way of cultivating plants by use of such plant characteristics.

As such plant cultivation systems, there are a plant cultivation system using natural light, such as sunlight, and a plant cultivation system using artificial light, such as fluorescent light.

Plant cultivation using natural light, which has been carried out conventionally, does not require costs to use the light but requires only a structure to expose cultivated plants to the sunlight. The sunlight cultivation system may thus be easily constructed with simple facilities, but has disadvantages that an amount of sunlight energy, a light exposure time, etc. cannot be controlled.

Whereas plant cultivation using artificial light may easily control an amount of light energy, a light exposure time, etc., but causes huge burdens, i.e., construction costs of an artificial light, electricity bills, etc.

### DISCLOSURE

[Technical Problem]

An object of the disclosed invention is to provide a multilayer plant cultivation system in which a cultivation zone is formed in a multilayer structure, the uppermost layer uses natural light and a lower layer uses artificial light so as to maximize efficiency of a plant cultivation space.

The other objectives and advantages will be understood by those skilled in the art from the following detailed description taken in conjunction with the accompanying drawings.

[Technical Solution]

One embodiment of a multilayer plant cultivation system has upper and lower layers, including first cultivation beds located on the upper layer so as to expose plants fixed thereto to natural light.

The multilayer plant cultivation system may further include second cultivation beds located on a lower layer for cultivating plants using artificial light.

The multilayer plant cultivation system may further include illuminators arranged on the lower layer so as to radiate artificial light to the plants on the lower layer (the artificial light cultivation plants).

The illuminators may be placed at an upper portion of the lower layer and the second cultivation beds may be placed at a lower portion of the lower layer. The illuminators and the second cultivation beds may be arranged to face each other.

Nutrient solution containers to accommodate the second cultivation beds together with a nutrient solution so as to supply nutrients to the artificial light cultivation plants may be arranged in all regions or some regions of the lower layer. The second cultivation beds may have a plate shape provided with a plurality of plant fixing holes arranged at predetermined intervals so as to fix the artificial light cultivation plants. The predetermined intervals may be spacings between plants decided according to kinds or growth stages of crops.

The plants desired to be cultivated using artificial light placed on the lower layer may be cultivated through one or more of an NFT method, a RAFT method, a drip irrigation method, an EBB & FLOW method and a spray culture method. A plurality of lower layers may be provided and the artificial light cultivation plants placed on each lower layer may be cultivated through the one or more methods.

The multilayer plant cultivation system may further include a nutrient solution supply pipe provided at one side of the first cultivation beds and/or the second cultivation beds so as to supply a nutrient solution.

A nutrient solution inlet may be formed at one end of each of the first cultivation beds and/or the second cultivation beds, a nutrient solution outlet may be formed at the other end of each of the first cultivation beds and/or the second cultivation beds, and each of the first cultivation beds and/or the second cultivation beds may be inclined at a designated slope so that the nutrient solution from the nutrient solution supply pipe is introduced into the nutrient solution inlet and then discharged from the nutrient solution outlet.

The multilayer plant cultivation system may further include bed supports configured to support the first cultivation beds and/or the second cultivation beds so as to be inclined at the designated slope.

The first cultivation beds and/or the second cultivation beds may have a hollow frame shape provided with plant fixing holes disposed on one side surface thereof at predetermined intervals.

The predetermined intervals may be spacings between plants decided according to kinds or growth stages of crops.

[Advantageous Effects]

As described above, a plant cultivation system in accordance with one embodiment of the present invention has a cultivation zone formed in a multilayer structure of which the uppermost layer uses natural light and a lower layer uses artificial light so as to perform plant cultivation, thereby providing an effect of maximizing efficiency in a plant cultivation space.

Further, the plant cultivation system may provide optimal spacings between cultivated plants according to kinds and growth stages of the cultivated plants.

The above and other objects, features and other advantages of the present invention will be clearly understood from the following detailed description taken in conjunction with the accompanying drawings.

### DESCRIPTION OF DRAWINGS

FIG. 1 is a view illustrating a multilayer plant cultivation system in accordance with one embodiment of the present invention.

FIG. 2 is a view illustrating a first cultivation bed or a second cultivation bed in accordance with one embodiment of the present invention.

FIG. 3 is a view illustrating arrangement of first cultivation beds or second cultivation beds, some of which are densely arranged, and, the remainder of which are arranged at sufficient intervals on bed supports.

FIG. 4 is a view illustrating installation of nutrient solution containers in all regions or some regions of a lower layer.

FIG. 5 is a view illustrating a first cultivation bed or a second cultivation bed in accordance with another embodiment of the present invention.

FIG. 6 is a view illustrating a structure in which both plants desired to be cultivated using natural light placed on an upper layer and plants desired to be cultivated using artificial light placed on a lower layer may be cultivated through an NFT method.

FIG. 7 is a view illustrating a structure in which both plants desired to be cultivated using natural light placed on an upper layer and plants desired to be cultivated using artificial light placed on a lower layer may be cultivated through a RAFT method or an EBB & FLOW method.

### BEST MODE

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments.

Wherever possible, the same reference numbers will be used throughout the drawings to refer to the same or like parts even though they are depicted in different drawings. In the following description of the present invention, a detailed description of known functions and configurations incorporated herein will be omitted when it may make the subject matter of the present invention rather unclear.

Further, the sizes, shapes, etc., of the elements shown in the drawings may be exaggerated for clarity and convenience in description. Also, terms specifically defined taking into consideration the configuration and functions obtained in accordance with the present invention are just to describe the embodiments of the present invention and do not limit the scope of the invention.

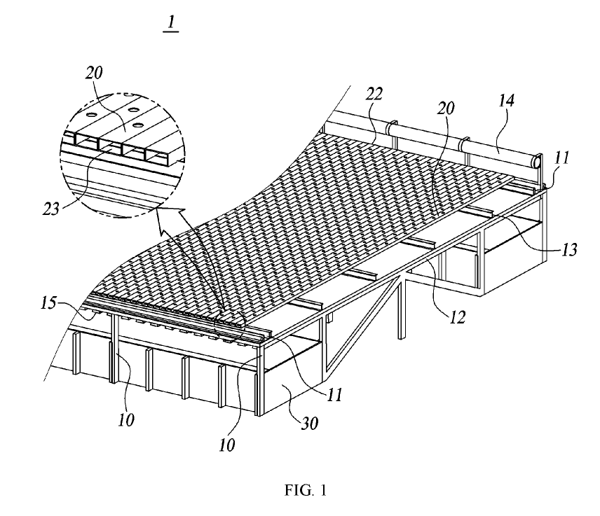

FIG. 1 is a view illustrating a multilayer plant cultivation system in accordance with one embodiment of the present invention. In more detail, FIG. 1 illustrates a plant cultivation system formed in a multilayer structure including an upper layer and a lower layer.

First, with reference to FIG. 1, a multilayer plant cultivation system 1 in accordance with one embodiment of the present invention will be described below.

The multilayer plant cultivation system 1 in accordance with this embodiment may have an upper layer and a lower layer, and include first cultivation beds 20, second cultivation beds (not shown) and illuminators 15.

Plants desired to be cultivated using natural light (natural light cultivation plants) may be fixed to the first cultivation beds 20, and the first cultivation beds 20 may be located on the upper layer so that the natural light cultivation plants are exposed to natural light radiated from outside. Here, the upper layer means the uppermost layer in the plant cultivation system formed in the multilayer structure. That is, no layer is located above the above-described upper layer so that the natural light cultivation plants can be exposed to sunlight. A transparent window may be provided above the plants.

Plants desired to be cultivated using artificial light may be fixed to the second cultivation beds, and the second cultivation beds may be located on the lower layer.

The illuminators 15 are provided on the lower layer and serve to radiate artificial light to the artificial light cultivation plants.

The illuminators 15 are arranged at the upper portion of the lower layer and the second cultivation beds are placed at the lower portion of the lower layer such that the illuminators 15 and the second cultivation beds face each other. Through such a structure, the artificial light cultivation plants are exposed to artificial light through the above-described illuminators 15.

Now, the multilayer plant cultivation system 1 will be described in more detail. In the multilayer plant cultivation system 1 in accordance with this embodiment, a plurality of support frames 10 are arranged vertically. An interlayer prop 12 is supported by the support frames 10. The interlayer prop 12 includes a plate or a plurality of frames, but is not limited thereto.

A plurality of bed supports 13 are arranged on the upper surface of the interlayer prop 12. Although, in this embodiment, the bed supports 13 have an “I”-frame shape, the bed supports 13 are not limited thereto.

The first cultivation beds 20 are placed on the upper surfaces of the bed supports 13. Here, a plurality of first cultivation beds 20 are provided. According to embodiments, the first cultivation beds 20 have a frame shape extending in the length direction. In this case, the bed supports 13 and the first cultivation beds 20 are arranged perpendicularly to each other.

The multilayer plant cultivation system 1 in accordance with this embodiment further includes a nutrient solution supply pipe 14. The nutrient solution supply pipe 14 is installed at one side of the first cultivation beds 20 or the second cultivation beds. Further, the nutrient solution supply pipe 14 is located at one side of the first cultivation beds 20 or the second cultivation beds.

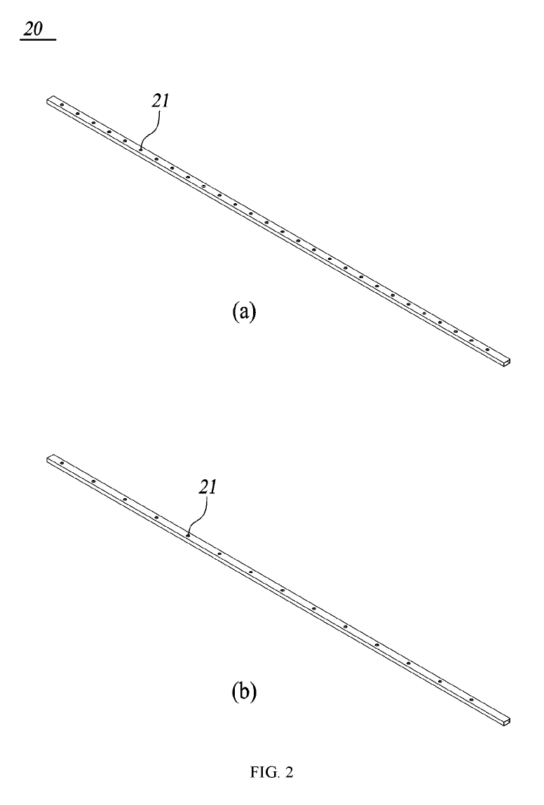

FIG. 2 is a view illustrating a first cultivation bed or a second cultivation bed in accordance with one embodiment of the present invention. As exemplarily shown in FIG. 2, intervals between plant fixing holes 21 of FIG. 2(b) are greater than intervals between plant fixing holes 21 of FIG. 2(a).

With reference to FIG. 2, the first cultivation bed 20 or the second cultivation bed have a hollow frame shape in which plant fixing holes 21 are provided on one side surface thereof at predetermined intervals. Here, the above-described intervals may be decided in consideration of spacings between plants according to kinds or growth stages of crops, i.e., plants desired to be cultivated. With reference to FIG. 2, it may be understood that spacings between plants shown in FIG. 2(b) are greater than spacings between plants shown in FIG. 2(a).

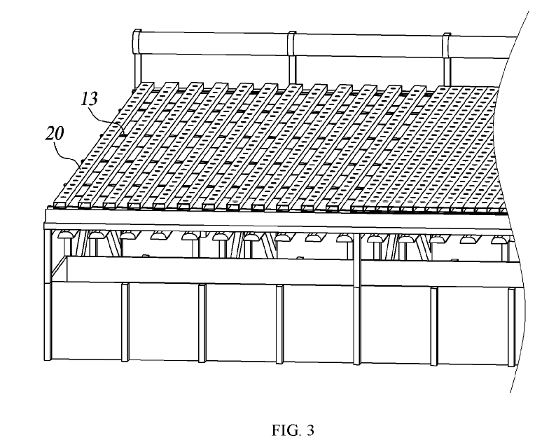

FIG. 3 is a view illustrating arrangement of first cultivation beds or second cultivation beds, some of which are densely arranged, and, the remainder of which are arranged at sufficient intervals on the bed supports 13.

With reference to FIG. 3, the first cultivation beds 20 or the second cultivation beds may be included so as to be simply placed on the bed supports 13. That is, the first cultivation beds 20 or the second cultivation beds may be freely arranged on and removed from the bed supports 13.

Therefore, a plant cultivator arranges a plurality of first cultivation beds 20 on the bed supports 13 densely or at sufficient intervals on the bed supports 13, thus being capable of disposing plant fixing holes 21 in consideration of spacings between plants desired to be cultivated.

According to embodiments, a nutrient solution inlet 22 may be formed at one end of the first cultivation bed 20 or the second cultivation bed, a nutrient solution outlet 23 may be formed at the other end of the first cultivation bed 20 or the second cultivation bed, and the first cultivation bed 20 or the second cultivation bed may be inclined at a designated slope so that a nutrient solution from the nutrient solution supply pipe 14 may be introduced into the nutrient solution inlet 22 and then discharged from the nutrient solution outlet 23. In this case, the bed supports 13 may support the first cultivation beds 20 or the second cultivation beds so as to have a designated slope.

A drain channel 11 may be disposed adjacent to the nutrient solution outlets 23. The drain channel 11 may serve to drain the nutrient solution discharged from the nutrient solution outlets 23.

Further, a drain channel 11 may be disposed adjacent to the nutrient solution inlets 22. In this case, if a plant cultivator removes the first cultivation beds 20 or the second cultivation beds for the purpose of cleaning the interlayer prop, etc., the drain channel 11 may serve to prevent the nutrient solution from the nutrient solution supply pipe 14 from falling directly to the interlayer prop.

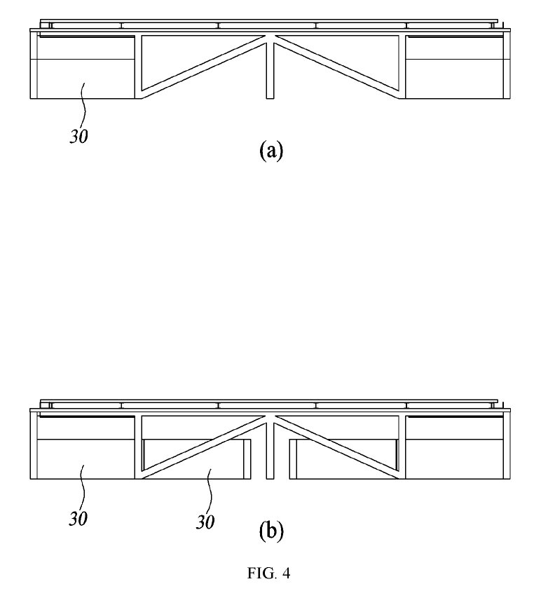

FIG. 4 is a view illustrating installation of nutrient solution containers in all regions or some regions of the lower layer. FIG. 4(a) illustrates an arrangement of the nutrient solution containers 30 in some regions of the lower layer, i.e., only the outer part of the lower layer, and FIG. 4(b) illustrates an arrangement of the nutrient solution containers 30 in all regions of the lower layer, i.e., both the outer and inner parts of the lower layer.

In all regions or some regions of the lower layer, nutrient solution containers 30, which may accommodate the second cultivation beds and the nutrient solution together so as to supply nutrients to plants desired to be cultivated using artificial light, may be installed. According to embodiments, the multilayer plant cultivation system 1 may extend in the length direction, and a system designer may arrange the nutrient solution containers 30 extending in the length direction in parallel. The designer may arrange the nutrient solution containers 30 at both outer parts of the lower layer, arrange the nutrient solution containers 30 at both inner parts of the lower layer, or arrange the nutrient solution containers 30 at all of both outer parts and both inner parts of lower layer.

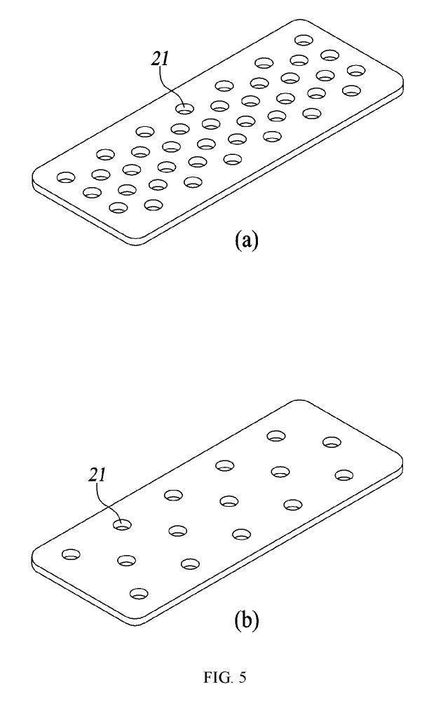

FIG. 5 is a view illustrating a first cultivation bed or a second cultivation bed in accordance with another embodiment of the present invention. Plant fixing holes 21 of FIG. 5(b) are arranged less densely than plant fixing holes 21 of FIG. 5(a).

The second cultivation beds accommodated in the nutrient solution container 30 may have a plate shape in which a plurality of plant fixing holes 21 to fix plants desired to be cultivated using artificial light are arranged at predetermined intervals. Here, the above-described intervals may be set in consideration of spacings between plants set according to kinds or growth stages of crops, i.e., plants desired to be cultivated.

With reference to FIG. 5, it may be understood that spacings between plants shown in FIG. 5(b) is greater than spacings between plants shown in FIG. 5(a).

In another aspect, FIG. 1 illustrates a structure in which plants desired to be cultivated using natural light placed on the upper layer may be cultivated through an NFT method and plants desired to be cultivated using artificial light placed on the lower layer may be cultivated through a RAFT method or an EBB & FLOW method.

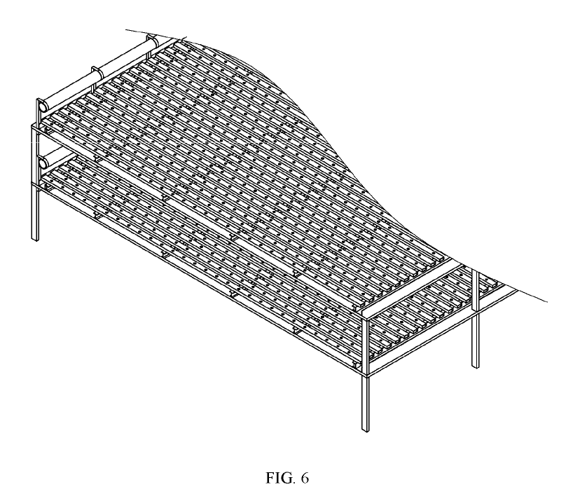

Further, FIG. 6 illustrates a structure in which both plants desired to be cultivated using natural light placed on the upper layer and plants desired to be cultivated using artificial light placed on the lower layer may be cultivated through the NFT method. With reference 6, it is shown that cultivation beds having a frame shape are disposed on both the upper and lower layers.

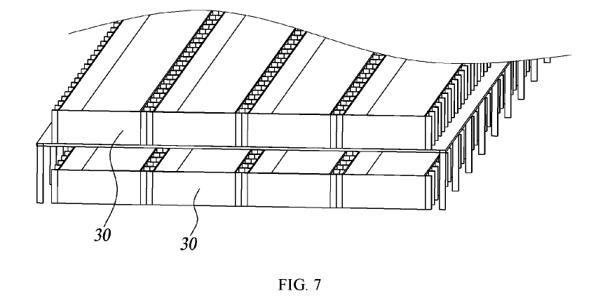

Further, FIG. 7 illustrates a structure in which both plants desired to be cultivated using natural light placed on the upper layer and plants desired to be cultivated using artificial light placed on the lower layer may be cultivated through the RAFT method or the EBB & FLOW method. With reference to FIG. 7, it is shown that nutrient solution containers 30 are arranged on both the upper and lower layers.

According to embodiments, plants desired to be cultivated using natural light placed on the upper layer may be cultivated through one or more of the NFT method, the RAFT method, a drip irrigation method, the EBB & FLOW method and a spray culture method.

According to embodiments, plants desired to be cultivated using artificial light placed on the lower layer may be cultivated through one or more of the NFT method, the RAFT method, the drip irrigation method, the EBB & FLOW method and the spray culture method.

Here, the NFT method may mean a method in which a nutrient solution flows to frame-shaped cultivation beds so as to be supplied to plants desired to be cultivated. The RAFT method may mean a method in which a nutrient solution container is filled with a nutrient solution and a plate-shaped cultivation bed, to which plants desired to be cultivated are fixed, floats in the nutrient solution so as to supply the nutrient solution to the plants desired to be cultivated. In the EBB & FLOW method, a structure similar to the structure in the RAFT method may be provided and filling a nutrient solution container with a nutrient solution and removal of the nutrient solution from the nutrient solution container may be repeated.

The spray culture method may mean a method in which such plate-shaped cultivation beds, to which plants desired to be cultivated are fixed, are located and a nutrient solution is sprayed onto the plants desired to be cultivated through a spraying-type water supply device.

The drip irrigation method may mean a method in which a nutrient solution is supplied to frame-shaped cultivation beds through a drip irrigation hose instead of a nutrient supply pipe.

Although not shown in the drawings, according to embodiments, the system may include a plurality of lower layers and plants desired to be cultivated using artificial light placed on each lower layer may be cultivated through one or more of the NFT method, the RAFT method, the drip irrigation method, the EBB & FLOW method and the spray culture method.

Further, although not shown in the drawings, according to embodiments, no nutrient solution container is provided on a lower layer and a spraying-type water supply device to spray a nutrient solution directly to roots of plants desired to be cultivated using artificial light fixed to second cultivation beds may be provided on the lower layer. The spraying-type water supply device may be, for example, a sprinkler.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Therefore, although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The disclosure relates to a plant cultivation system which may cultivate plants.

One embodiment of the plant cultivation system of the present invention has a plurality of layers, plants placed on the uppermost layer are cultivated using natural light and plants placed on the lower layer are cultivated using artificial light.

Therefore, effective space utilization may be achieved.

1. A multilayer plant cultivation system having upper and lower layers, comprising:
first cultivation beds for fixing plants desired to be cultivated using natural light and located on the upper layer so as to expose the natural light cultivation plants to the natural light radiated from outside;
second cultivation beds for fixing plants desired to be cultivated using artificial light and located on a lower layer; and
illuminators arranged on the lower layer so as to radiate the artificial light to the artificial light cultivation plants.

2. The multilayer plant cultivation system according to claim 1, wherein the illuminators are placed at an upper portion of the lower layer, the second cultivation beds are placed at a lower portion of the lower layer and the illuminators and the second cultivation beds are arranged to face each other.

3. The multilayer plant cultivation system according to claim 1, wherein nutrient solution containers to accommodate the second cultivation beds and a nutrient solution together so as to supply nutrients to the artificial light cultivation plants are arranged in all regions or some regions of the lower layer.

4. The multilayer plant cultivation system according to claim 3, wherein the second cultivation beds have a plate shape provided with a plurality of plant fixing holes arranged at predetermined intervals so as to fix the artificial light cultivation plants.

5. The multilayer plant cultivation system according to claim 1, wherein the artificial light cultivation plants placed on the lower layer are cultivated through one or more of an NFT method, a RAFT method, a drip irrigation method, an EBB & FLOW method and a spray culture method.

6. The multilayer plant cultivation system according to claim 5, wherein the lower layer includes a plurality of layers, and the plants placed on each of the layers are cultivated through the one or more methods.

7. The multilayer plant cultivation system according to claim 1, further comprising a nutrient solution supply pipe arranged at one side of the first cultivation beds and/or the second cultivation beds so as to supply a nutrient solution.

8. The multilayer plant cultivation system according to claim 7, wherein a nutrient solution inlet is formed at one end of the first and/or second cultivation beds, a nutrient solution outlet is formed at the other end thereof, and the first and/or second cultivation beds are inclined at a designated slope so that the nutrient solution from the nutrient solution supply pipe is introduced into the nutrient solution inlet and then discharged from the nutrient solution outlet.

9. The multilayer plant cultivation system according to claim 8, further comprising bed supports configured to support the first cultivation beds and/or the second cultivation beds to be inclined at the designated slope.

10. The multilayer plant cultivation system according to claim 7, wherein the first cultivation beds and/or the second cultivation beds have a hollow frame shape provided with plant fixing holes disposed on one side surface thereof at predetermined intervals.

11. The multilayer plant cultivation system according to claim 4 or 10, wherein the predetermined intervals are spacings between plants decided according to kinds or growth stages of crops.

12. The multilayer plant cultivation system according to claim 10, wherein the predetermined intervals are spacings between plants decided according to kinds or growth stages of crops.
